(19) United States
(12) Patent Application Publication
(10) Pub. No.: US 2026/0099621 A1
(43) Pub. Date: Apr. 9, 2026

(54) IMPLEMENTING MULTIPLE SECURITY LEVELS OF CONTROL OVER PREDICATE ACCESS TO FINE-GRAINED PRIVACY-PRESERVING COLUMNS

(71) Applicant: Beijing Volcano Engine Technology Co., Ltd., Beijing (CN)

(72) Inventor: Xinying Yang, Los Angeles, CA (US)

(21) Appl. No.: 18/819,582

(22) Filed: Aug. 29, 2024

(51) Int. Cl. G06F 21/62

(52) U.S. Cl. CPC G06F 21/6227; G06F 16/2379; G06F 16/245

(57) ABSTRACT

The present disclosure describes techniques for implementing multiple security levels of control over predicate access to fine-grained privacy-preserving columns. A predicate catalog table is configured. The predicate table is configured for controlling predicate survivor users to access the fine-grained privacy-preserving columns. A first instruction of granting a user predicate access to one of the fine-grained privacy-preserving columns is received from an owner of the one of the fine-grained privacy-preserving columns. It is determined if there is a match based on comparing identification information and operator information in the predicate catalog table with information indicated by the first instruction. In response to determining that there is no match, a new row is created in the predicate catalog table based on the first instruction. The new row is configured to control the user's predicate access to the one of the fine-grained privacy-preserving columns.

### BACKGROUND

Certain data may be sensitive or confidential. Permission to such data may be restricted to a particular set of parties. For example, sensitive or confidential data may be encrypted so that only authorized parties can access it. As the quantity of sensitive or confidential data continues to increase, people continue to desire new ways for managing access to data.

### BRIEF DESCRIPTION OF THE DRAWINGS

The following detailed description may be better understood when read in conjunction with the appended drawings. For the purposes of illustration, there are shown in the drawings example embodiments of various aspects of the disclosure; however, the invention is not limited to the specific methods and instrumentalities disclosed.

FIG. 1 shows an example system for implementing multiple security levels of control over predicate access to fine-grained privacy-preserving columns in accordance with the present disclosure.

FIG. 2 shows an example system for implementing multiple security levels of control over predicate access to fine-grained privacy-preserving columns in accordance with the present disclosure.

FIG. 3 shows an example predicate catalog table in accordance with the present disclosure.

FIG. 4 shows an example predicate catalog table in accordance with the present disclosure.

FIG. 5 shows an example predicate catalog table in accordance with the present disclosure.

FIG. 6 shows an example predicate catalog table in accordance with the present disclosure.

FIG. 7 shows an example predicate catalog table in accordance with the present disclosure.

FIG. 8 shows an example predicate catalog table in accordance with the present disclosure.

FIG. 9 shows an example predicate catalog table in accordance with the present disclosure.

FIG. 10 shows an example predicate catalog table in accordance with the present disclosure.

FIG. 11 shows an example process for implementing multiple security levels of control over predicate access to fine-grained privacy-preserving columns in accordance with the present disclosure.

FIG. 12 shows an example process for implementing multiple security levels of control over predicate access to fine-grained privacy-preserving columns in accordance with the present disclosure.

FIG. 13 shows an example process for implementing multiple security levels of control over predicate access to fine-grained privacy-preserving columns in accordance with the present disclosure.

FIG. 14 shows an example process for implementing multiple security levels of control over predicate access to fine-grained privacy-preserving columns in accordance with the present disclosure.

FIG. 15 shows an example process for implementing multiple security levels of control over predicate access to fine-grained privacy-preserving columns in accordance with the present disclosure.

FIG. 16 shows an example process for implementing multiple security levels of control over predicate access to fine-grained privacy-preserving columns in accordance with the present disclosure.

FIG. 17 shows an example computing device which may be used to perform any of the techniques disclosed herein.

### DETAILED DESCRIPTION OF ILLUSTRATIVE EMBODIMENTS

An in-enclave (e.g., fully hardware encrypted) relational database that supports privacy-preserving and verifiable functionalities can be implemented by residing an entire database management system (DBMS) in a hardware-based security engine that isolates and protects data in use against attack within a virtual machine (VM). In this fully hardware encrypted database architecture, all memory, central processing unit(s), and input/output (I/O) security can be protected from data leaks. Thus, any DBMS internally used data structures and data stores that do not have explicit retrieval interfaces cannot be viewed by adversaries, such as system and physical logs.

When creating or altering a table in this hardware encrypted database architecture, a privacy-preserving column can be defined with an additional keyword “SECRET.” The owner of the secret column can see the plaintext. Other users cannot observe the plaintext in any way, such as for data retrieval, predicate handling, log probing, or statistic viewing. The owner can execute data control language (DCL) operations to grant column visibility to another user (e.g., using the command “GRANT VIEWER DCL”) and to remove or revoke visibility control from a user (e.g., using a “DENY” or “REVOKE” command). These DCL operations can be only executed by the secret column owner to prevent unexpected operations from high-privileged roles such as database administrators (DBAs).

An owner of a privacy-preserving column can control visibility of a privacy-preserving column by granting viewing access to, denying viewing access from, or revoking viewing access from another user (e.g., using a GRANT, DENY, or REVOKE command, respectively). If a user that has not been granted viewing access to a privacy-preserving column attempts to executes a DML command with a predicate that contains the privacy-preserving column, an error is returned. The owner of a privacy-preserving column may want to enable a user that is not a viewer of the privacy-preserving column to have limited access (e.g., predicate access) to the secret information in the privacy-preserving column. To enable the user to have predicate access to the secret information in the privacy-preserving column, the owner can grant the user predicate access to the privacy-preserving column (e.g., using a GRANT command). The owner can specify one or more predicate operators that the user can run, a quantity of times the user can run a query containing the predicate operator(s), and a time interval after which the quantity of times the user can run a query containing the predicate operator(s) can be reset. The owner can similarly revoke the user's predicate access to the privacy-preserving column (e.g., using a REVOKE command).

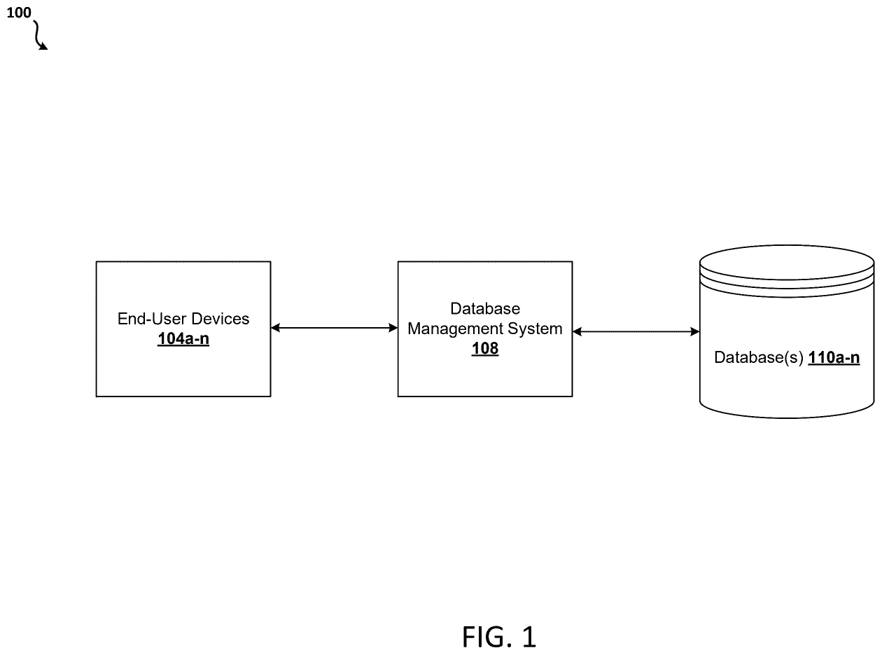

Described here are improved techniques for implementing multiple security levels of control over predicate access to fine-grained privacy-preserving columns. The techniques described herein enable owners of fine-grained privacy-preserving columns to control predicate access to the fine-grained privacy-preserving columns. FIG. 1 shows an example system 100 for managing ownership of fine-grained privacy-preserving columns in accordance with the present disclosure. The system 100 includes a plurality of end user devices 104a-n, a DBMS 108, and at least one database 110.

The at least one database 110 can store data, such as in the form of one or more tables. Each of the table(s) can include one or more fine-grained privacy-preserving columns. Each fine-grained privacy-preserving column can include secret information. Each fine-grained privacy-preserving column can be defined with the additional keyword “SECRET.” Only an owner of a particular fine-grained privacy-preserving column can be allowed to execute DCL operations associated with that fine-grained privacy-preserving column. The owner of the particular fine-grained privacy-preserving column can be associated with one or more of the plurality of end user devices 104a-n. Only the one or more end user devices associated with the owner can be used to execute DCL operations associated with that fine-grained privacy-preserving column.

The DBMS 108 can create a predicate catalog table. The predicate catalog table can be configured for controlling predicate survivor users'access to the fine-grained privacy-preserving columns. Each of the predicate survivor users can be granted access to query at least one of the fine-grained privacy-preserving columns using at least one predicate operator. The at least one predicate operator can include, one or more of the following operators: = (e.g., equal to), > (e.g., greater than), < (e.g., less than), ≤ (e.g., less than or equal to), ≥ (e.g., greater than or equal to), “not in,” “between,” and/or any other operator. In some embodiments, a predicate survivor user can be granted access to query at least one of the fine-grained privacy-preserving columns using any predicate operator (e.g., when operation information in a row of the predicate catalog table has a “null” value).

Each row of the predicate catalog table can include identification information. The identification information in each row of predicate catalog table can include identification information of the particular fine-grained privacy-preserving column, identification information of an owner of the particular fine-grained privacy-preserving column, and identification information of the particular predicate survivor user. Each row of the predicate catalog table can include operator information. The operator information can indicate the one or more predicate operators that the predicate survivor user can use to query the fine-grained privacy-preserving column. Each row of the predicate catalog table can include control information for controlling a particular predicate survivor user's access to a particular fine-grained privacy-preserving column. The control information in each row of the predicate catalog table can include information indicating a quantity limit that the particular predicate survivor user is allowed to query the particular fine-grained privacy-preserving column using the one or more predicate operators (e.g., a quantity of times that the predicate survivor user is allowed to query the particular fine-grained privacy-preserving column using the one or more predicate operators). The control information in each row of the predicate catalog table can include information indicating an interval at which the quantity limit is to be reset (e.g., a time interval after which the quantity of times the user can run a query containing the predicate operator(s) is to be reset).

A user can be granted predicate access to one of the fine-grained privacy-preserving columns in response to receiving a first instruction from an owner of the fine-grained privacy-preserving column. The first instruction can be associated with identification information of the owner. The owner can be associated with a first end user device 104a among the plurality of end user devices 104a-n. The first instruction can be received from the first end user device 104a. The owner of the fine-grained privacy-preserving column is the only user that has permission to execute DCL operations associated with the fine-grained privacy-preserving column.

The first instruction can include identification information, such as identification information of the particular fine-grained privacy-preserving column identification information of the user to which the owner wants to grant predicate access. The first instruction can include operator information indicating one or more predicate operators that the user to which predicate access is being granted can use to query the fine-grained privacy-preserving column. The first instruction can include control information indicating a quantity limit that the user is allowed to query the particular fine-grained privacy-preserving column using the one or more predicate operators (e.g., a quantity of times that the user is allowed to query the particular fine-grained privacy-preserving column using the one or more predicate operators). The control information in the first instruction can indicate an interval at which the quantity limit is to be reset (e.g., a time interval after which the quantity of times the user can run a query containing the predicate operator(s) is to be reset).

It can be determined if any row in the predicate catalog table matches the first instruction based on comparing the identification information and the operator information in each existing row of the predicate catalog table with information associated with the first instruction. An existing row in the predicate catalog table can match the first instruction if the existing row includes the same identification information and operator information as the identification information and operator information indicated by (e.g., associated with, included in) the first instruction.

In embodiments, no match exists between any existing row in the predicate catalog table and the first instruction. It can be determined that no match exists between any existing row in the predicate catalog table and the first instruction if the predicate catalog table does not include any row that includes the same identification information and operator information as the identification information and operator information indicated by the first instruction. In response to determining that there is no match, the DBMS 108 can create a new row in the predicate catalog table. The new row can be created based on the first instruction. For example, the new row can be created based on the first instruction, such as the identification information, the operator information, and the control information indicated by the first instruction. The new row can be configured to control the user's predicate access to the fine-grained privacy-preserving column.

In other embodiments, a match exists between an existing row in the predicate catalog table and the first instruction. It can be determined that a match exists between the existing row in the predicate catalog table and the first instruction if the predicate catalog table includes an existing row that includes the same identification information and operator information as the identification information and operator information indicated by the first instruction. In response to determining that there is a match, the DBMS 108 can update the control information in the existing row of the predicate catalog table based on the first instruction. For example, the control information in the existing row of the predicate catalog table can be replaced with the control information indicated by the first instruction.

In embodiments, a row in the predicate catalog table can include control information that indicates a quantity limit that a particular predicate survivor user is allowed to query a particular fine-grained privacy-preserving column using one or more specified predicate operators, and an interval having a number value. The number value can be indicative of any time period (e.g., one day, two days, one week, one month, etc.) If the interval in a row has a number value, this indicates that the quantity limit in that row is to be reset when the time period expires or has lapsed. The DBMS 108 can reset the quantity limit in the row at every interval in response to determining that the interval in the new row has a number (e.g., non-null) value, regardless of whether or not the number of queries executed by the particular predicate survivor user has reached the quantity limit.

In embodiments, a row in the predicate catalog table can include control information that indicates a quantity limit that a particular predicate survivor user is allowed to query a particular fine-grained privacy-preserving column using one or more specified predicate operators, and an interval having a null value. If the interval in a row has a null value, this indicates that the quantity limit in that row is never to be reset. If the interval in a row has a null value, and it is determined that a number of queries executed by the particular predicate survivor user has reached the quantity limit, the DBMS 108 can delete the row from the predicate catalog table instead of resetting the quantity limit.

Predicate access to a fine-grained privacy-preserving column can be revoked from a user. For example, the owner may have granted the user predicate access to the fine-grained privacy-preserving column accidentally (e.g., by mistake). In embodiments, the owner of a fine-grained privacy-preserving column may want to completely revoke the user's predicate access to the fine-grained privacy-preserving column. For example, the owner of the fine-grained privacy-preserving column may want to revoke the user's ability to query the fine-grained privacy-preserving column using any predicate operator.

To completely revoke the user's predicate access to the fine-grained privacy-preserving column, the owner can send a second instruction (e.g., to the DBMS 108) to completely revoke the user's predicate access to the fine-grained privacy-preserving column. The second instruction can be associated with identification information of the owner. The second instruction can include identification information, such as identification information of the particular fine-grained privacy-preserving column and identification information of the user from which the owner wants to revoke predicate access. The second instruction can include operator information having a null value, indicating that the owner wants to revoke the user's ability to query the fine-grained privacy-preserving column using any predicate operator (not just a specific predicate operator).

In response to receiving the second instruction, the DBMS 108 can identify all rows in the predicate catalog table that that match the identification information indicated by the second instruction. For example, the DBMS 108 can identify all rows in the predicate catalog table that that include the identification information matching the identification information indicated by the second instruction. A row in the predicate catalog table can include identification information that matches the identification information indicated by the second instruction if the row and the second instruction both are associated with the same identifier of the one of the fine-grained privacy-preserving columns, the same identifier of the owner of the one of the fine-grained privacy-preserving columns, and the same identifier of the user. All of the matching rows can be deleted from the predicate catalog table. Deleting all of the matching rows can completely revoke the user's predicate access to the fine-grained privacy-preserving column.

In other embodiments, the owner of a fine-grained privacy-preserving column may want to revoke the user's predicate access to the fine-grained privacy-preserving column using only a specific predicate operator. To revoke the user's predicate access to the fine-grained privacy-preserving column using only a specific predicate operator, the owner can send a third instruction (e.g., to the DBMS 108) to revoke the user's predicate access to the fine-grained privacy-preserving column using the specific predicate operator. The third instruction can be associated with identification information of the owner. The third instruction can include identification information, such as identification information of the particular fine-grained privacy-preserving column and identification information of the user from which the owner wants to revoke predicate access. The third instruction can include the specific predicate operator.

In response to receiving the third instruction, the DBMS 108 can identify one or more rows in the predicate catalog table that match the identification information indicated by (e.g., associated with, included in) the third instruction. For example, the DBMS 108 can identify the row(s) in the predicate catalog table that that include the identification information matching the identification information indicated by the third instruction. A row in the predicate catalog table can include identification information that matches the identification information indicated by the third instruction if the row and the third instruction both are associated with the same identifier of the one of the fine-grained privacy-preserving columns, the same identifier of the owner of the one of the fine-grained privacy-preserving columns, and the same identifier of the user (i.e., the predicate survivor user).

It can be determined if operator information in one of the identified row(s) only covers the specific predicate operator. For example, it can be determined if operator information in one of the row(s) exactly matches the specific predicate operator. If the operator information in one of the row(s) only covers the specific predicate operator, that row can be deleted from the predicate catalog table. Deleting the row can revoke the user's predicate access to the fine-grained privacy-preserving column using the specific predicate operator. Additionally, or alternatively, if the operator information in one of the row(s) has a null value, this indicates that the operator information that row covers both the specific predicate operator and other predicate operators in addition to the specific predicate operator. If it is determined that the operator information in the at least one row covers other predicate operators in addition to the specific predicate operator, the predicate catalog table can be updated to only cover the other predicate operators. Updating the operator information in the predicate catalog table to only cover the other predicate operators can revoke the user's predicate access to the fine-grained privacy-preserving column using the specific predicate operator.

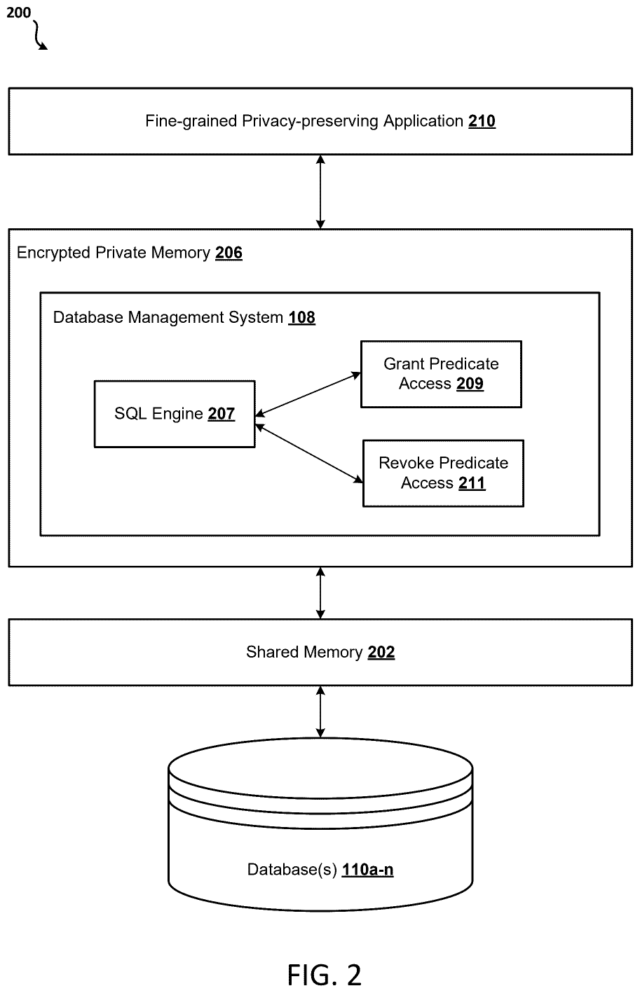

FIG. 2 shows an example system 200 for implementing multiple security levels of control over predicate access to fine-grained privacy-preserving columns in accordance with the present disclosure. The system 200 includes the DBMS 108 and the at least one database 110. The DBMS 108 can be contained in an encrypted private memory 206. The DBMS 108 can be in communication with the at least one database 110 via shared memory 202.

The DBMS 108 can support fine-grained privacy-preserving application(s) 210. To fulfill flexible data privacy, the fined-grained approach can be utilized to protect privacy at the column level. For example, an employee data table can contain sensitive information such as salary information. The DBMS 108 has to guarantee that no users other than human resource roles, including database administrators, can view the contents. The DBMS 108 can include a SQL engine 207. The SQL engine 207 can receive commands (e.g., SQL commands) from end users (e.g., from end-user devices 104a-n). In response to the commands received from the end users, the SQL engine 207 can cause predicate access grants 209 and revoking of predicate access grants 211.

The DBMS 108 can rely on a trust execution environment (TEE)-based virtual machine (VM) environment. The TEE-based VM environment can provide execution domain isolation by encryption of memory and registers, integrity measurement, and remote attestation to ensure data confidentiality. VM instances do not require additional development of a library operating system (OS) to support application workloads, thereby conserving engineering resources. Moreover, VM instances have the ability to fully utilize all CPU and memory resources available on a physical node. This advantage facilitates the management of large-memory workloads entirely within secure memory, minimizing I/O operations and boosting performance significantly.

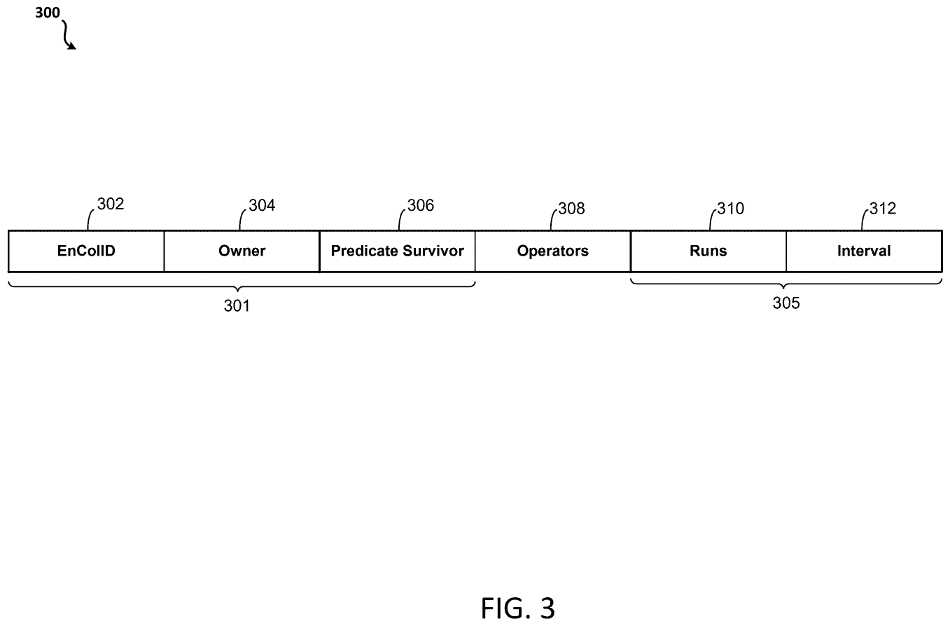

FIG. 3 shows an example predicate catalog table 300. A DBMS (e.g., the DBMS 108) can create the predicate catalog table 300. The predicate catalog table 300 can be configured to control the access of predicate survivor users to fine-grained privacy-preserving columns. Each of the predicate survivor users can be granted access to query at least one of the fine-grained privacy-preserving columns using at least one predicate operator. The at least one predicate operator can include, one or more of the following operators: = (e.g., equal to), > (e.g., greater than), < (e.g., less than), ≤ (e.g., less than or equal to), ≥ (e.g., greater than or equal to), “not in,” “between,” “null,” and/or any other operator.

Each row of the predicate catalog table 300 can include identification information 301. The identification information 301 in each row of predicate catalog table 300 can include the column ID information 302 of the particular fine-grained privacy-preserving column, identification information 304 of an owner of the particular fine-grained privacy-preserving column, and identification information 306 of the particular predicate survivor user. Each row of the predicate catalog table can include operator information 308. The operator information 308 can indicate the one or more predicate operators that the predicate survivor user can use to query the fine-grained privacy-preserving column. Each row of the predicate catalog table can include control information 305 for controlling a particular predicate survivor user's access to a particular fine-grained privacy-preserving column. The control information 305 in each row of the predicate catalog table can include quantity limit information 310 indicating a quantity limit that the particular predicate survivor user is allowed to query the particular fine-grained privacy-preserving column using the one or more predicate operators (e.g., a quantity of times that the predicate survivor user is allowed to query the particular fine-grained privacy-preserving column using the one or more predicate operators). The control information 305 in each row of the predicate catalog table can include interval information 312 indicating an interval at which the quantity limit is to be reset (e.g., a time interval after which the quantity of times the user can run a query containing the predicate operator(s) is to be reset).

An owner of one of the fine-grained privacy-preserving columns may want to grant, to a user, predicate access to one of the fine-grained privacy-preserving columns. The owner may send a first instruction. The first instruction may be associated with identification information of the owner (e.g., owner ID “user1”). The first instruction can include identification information. The identification information can include identification information of the particular fine-grained privacy-preserving column (e.g., column ID “uid1”). The identification information can include identification information of the user to which the owner wants to grant predicate access (e.g., predicate survivor ID “user2”). The first instruction can include operator information indicating one or more predicate operators that the user to which predicate access is being granted can use to query the fine-grained privacy-preserving column. For example, the operator information can include a “null” value, indicating that the user to which predicate access is being granted can use any available operator to query the fine-grained privacy-preserving column. The first instruction can include control information indicating a quantity limit that the user is allowed to query the particular fine-grained privacy-preserving column using the one or more predicate operators (e.g., a quantity of “100”). The control information in the first instruction can indicate an interval at which the quantity limit is to be reset (e.g., a time interval of “1” day). The first instruction can instruct the DBMS 108 to grant user2 predicate access to query the column “uid1” 100 times each day using any available predicate operator.

In response to receiving the first instruction from the owner of the fine-grained privacy-preserving column, it can be determined if any existing row in the predicate catalog table 300 matches the first instruction. It can be determined if any existing row in the predicate catalog table 300 matches the first instruction based on comparing the identification information and the operator information in each existing row of the predicate catalog table 300 with information associated with the first instruction. An existing row in the predicate catalog table 300 can match the first instruction if the existing row and the first instruction indicate the same identification information and the same operator information.

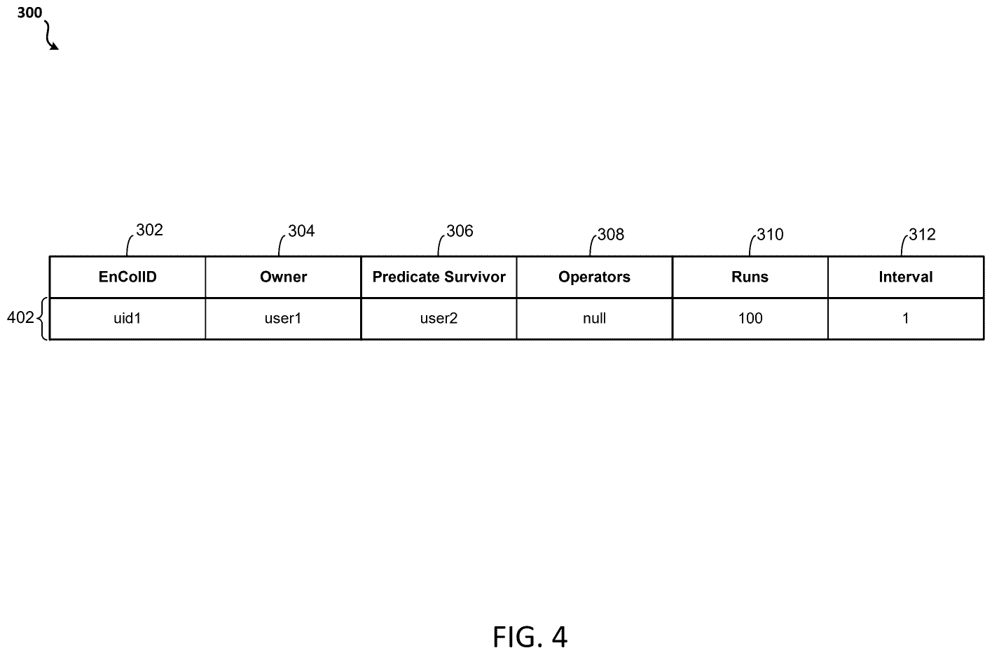

If it is determined that no match exists between any existing row in the predicate catalog table 300 and the first instruction, a new row can be created in the predicate catalog table 300. FIG. 4 shows an example predicate catalog table 300 that has been updated to include a new row 402 in response to determining that no match exists between any existing row in the predicate catalog table 300 and the first instruction. The new row 402 can correspond to the first instruction. The new row 402 can be created based on the first instruction. For example, the new row 402 can be created based on the information indicated by the first instruction, such as the identification information, the operator information, and the control information indicated by the first instruction. For example, the new row 402 can be populated with the column ID “uid1,” the owner ID “user1,” the predicate survivor ID “user2,” the “null” value covering all operators, the quantity of “100,” and the time interval of “1” (e.g., indicative of “1” day).

The owner of one of the fine-grained privacy-preserving columns may want to modify the user's predicate access to the fine-grained privacy-preserving column associated with the column ID “uid1” using all operators indicated by the “null” value. The owner may send a modified instruction. The modified instruction can include the same identification information as the first instruction (e.g., column ID “uid1,” and predicate survivor ID “user2”). The first instruction can include the same operator information as the first instruction (e.g., the “null” value). The modified instruction can include different control information than the first instruction. The different control information can include a different quantity limit and/or a different interval than the first instruction. The different control information can indicate, for example, a different quantity limit “1000” and a different time interval of “15” days. The modified instruction can instruct the DBMS 108 to grant user2 predicate access to query the column “uid1” 1000 times every fifteen days (instead of 100 times every day) using any available predicate operator.

In response to receiving the modified instruction from the owner of the fine-grained privacy-preserving column, it can be determined if any existing row in the predicate catalog table 300 matches the modified instruction. It can be determined if any existing row in the predicate catalog table 300 matches the modified instruction based on comparing the identification information and the operator information in each existing row of the predicate catalog table 300 with information associated with the modified instruction. An existing row in the predicate catalog table 300 can match the modified instruction if the existing row and the modified instruction indicate the same identification information and the same operator information.

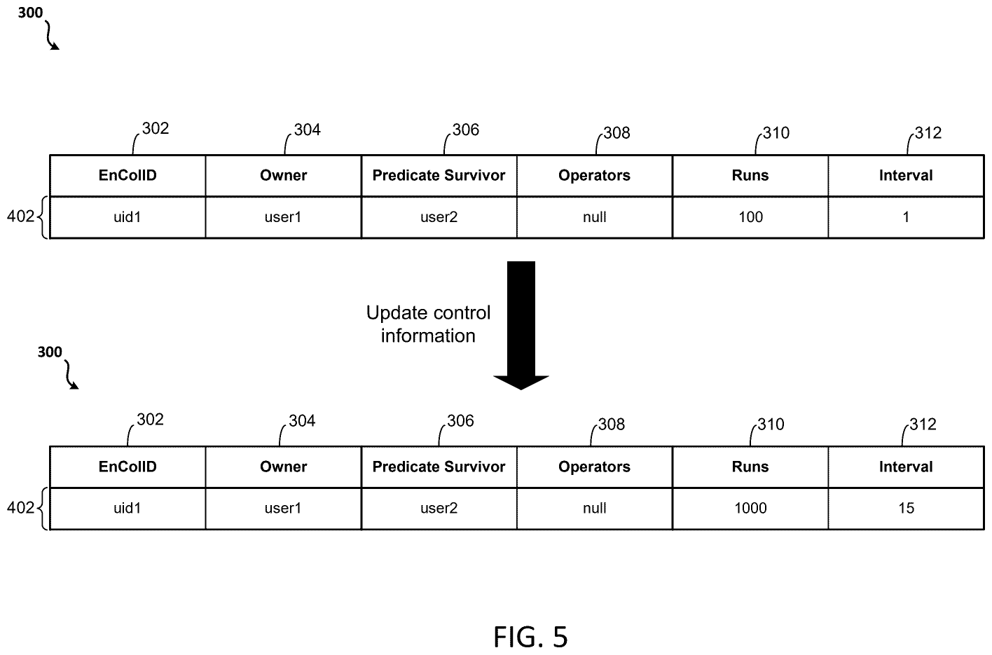

If it is determined that a match exists between an existing row in the predicate catalog table 300 and the modified instruction, the control information 305 in the existing row can be updated in the predicate catalog table 300. FIG. 5 shows an example predicate catalog table 300 that has been updated in response to determining that a match exists between the existing row 402 in the predicate catalog table 300 and the modified instruction. The existing row 402 can be updated to correspond to the modified instruction. For example, the row 402 can be modified based on the different control information contained in the modified instruction, such as the different quantity limit and/or the different time interval. For example, the control information 305 in the modified row 402 can reflect the different quantity limit “1000” and the different time interval of “15” days.

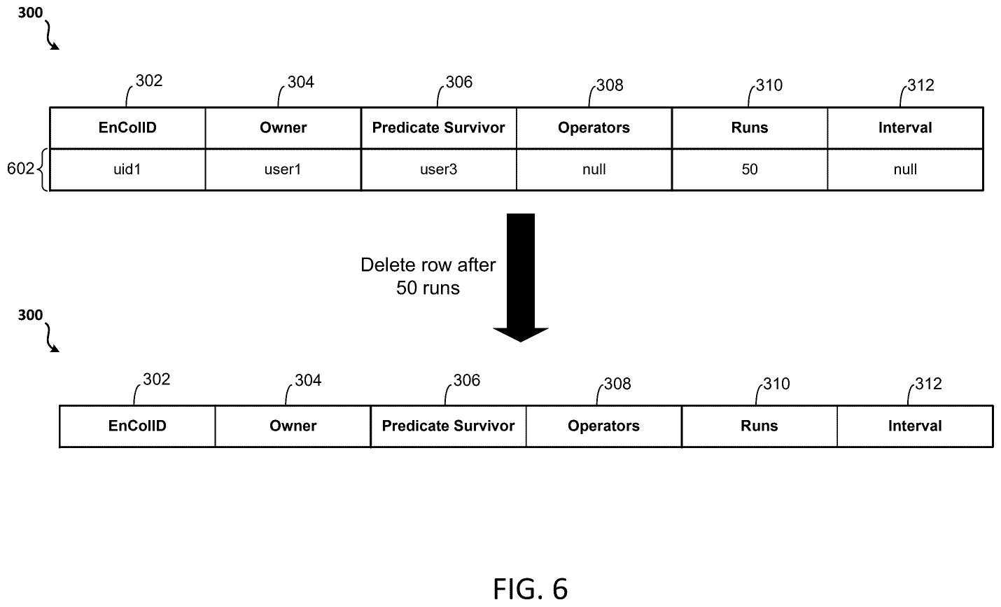

As shown in FIG. 6, a row 602 in the predicate catalog table 300 can include control information 305 that includes interval information 312 having a null value. If the interval 312 has a null value, this indicates that the quantity limit indicated by the quantity limit information 310 in that row is never to be reset. In response to determining that a number of queries executed by the particular predicate survivor user (e.g., a user associated with predicate survivor ID “user3”) has reached the quantity limit of 50, the row 602 can be deleted.

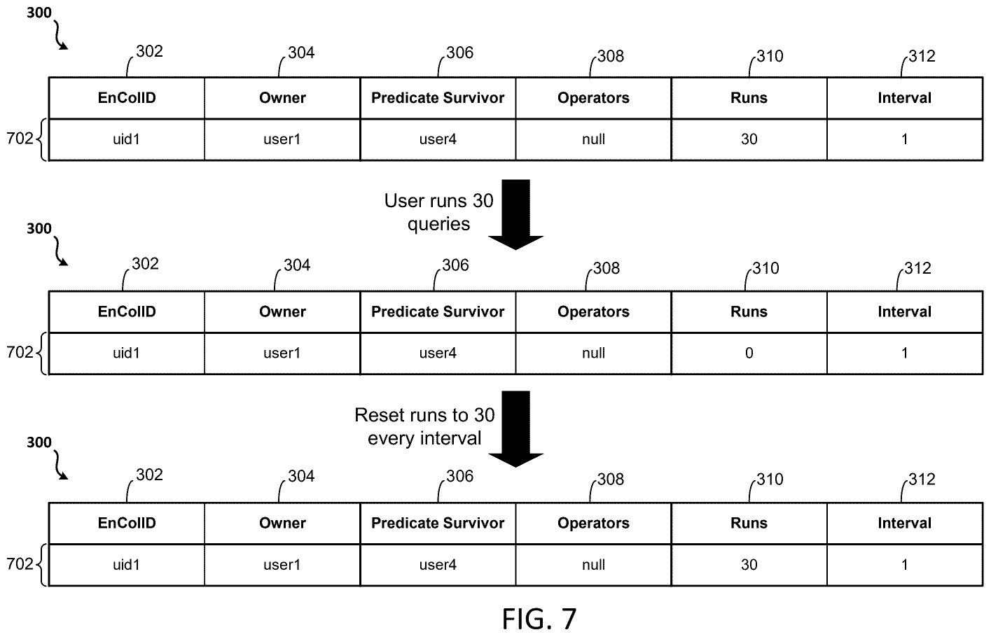

As shown in FIG. 7, a row 702 in the predicate catalog table 300 can include control information 305 that includes interval information 312 having a non-null value (e.g., a number value). If the interval 312 has a non-null value, this indicates that the quantity limit indicated by the quantity limit information 310 in that row is to be reset every interval, regardless of whether or not the number of queries executed by the particular predicate survivor user has reached the quantity limit indicated by the quantity limit information 310. In the example of FIG. 7, the row 702 includes quantity limit information 310 having a value of 30 runs and interval information 312 having a value of one day. The particular predicate survivor user (e.g., a user associated with predicate survivor ID “user4”) can therefore query the fine-grained privacy-preserving column associated with the column ID “uid1” up to 30 times each day using any available operator. If the predicate survivor user (e.g., a user associated with predicate survivor ID “user4”) queries the fine-grained privacy-preserving column associated with the column ID “uid1” 30 times in a single day, the quantity limit indicated by the quantity limit information 310 in the row 702 can be modified to indicate that the predicate survivor user cannot query the fine-grained privacy-preserving column associated with the column ID “uid1” any more times in the single day. When the day is over (e.g., when a new interval starts), the quantity limit indicated by the quantity limit information 310 in the row 702 can be reset to 30.

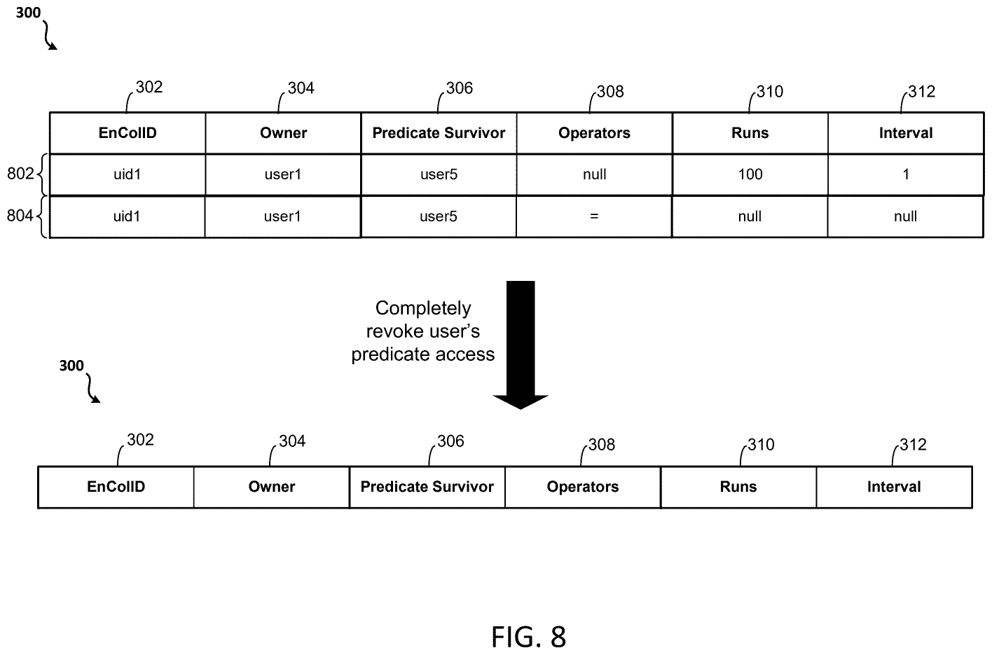

In embodiments, predicate access to a fine-grained privacy-preserving column can be completely revoked from a user. FIG. 8 shows an example predicate catalog table 300 that is modified to completely revoke predicate access to the fine-grained privacy-preserving column associated with the column ID “uid1” from a user associated with predicate survivor ID “user5”. The owner of the fine-grained privacy-preserving column may want to revoke the user's ability to query the fine-grained privacy-preserving column using any predicate operator. To completely revoke the user's predicate access to the fine-grained privacy-preserving column, the owner can send an instruction to completely revoke the user's predicate access to the fine-grained privacy-preserving column. The instruction can be associated with identification information of the owner (e.g., owner ID “user1”).

The instruction can include identification information of the particular fine-grained privacy-preserving column (e.g., column ID “uid1”). The instruction can include identification information of the user from which the owner wants to completely revoke predicate access (e.g., predicate survivor ID “user5”). The instruction can include operator information indicative of a null value, indicating that the owner wants to revoke the user's ability to query the fine-grained privacy-preserving column using any predicate operator (not just a specific predicate operator).

In response to receiving the instruction, the DBMS 108 can identify all rows in the predicate catalog table 300 that that match the identification information indicated by the instruction. For example, the DBMS 108 can identify all rows in the predicate catalog table 300 that that include the column ID “uid1” as the identification information 302, the owner ID “user1” as the identification information 304, and the predicate survivor ID “user5” as the identification information 306. In the example of FIG. 8, the row 802 and the row 804 both match the identification information indicated by the instruction. All of the matching rows, such as the row 802 and the row 804, can be deleted from the predicate catalog table 300. Deleting all of the matching rows can completely revoke the user's predicate access to the fine-grained privacy-preserving column associated with the column ID “uid1.”

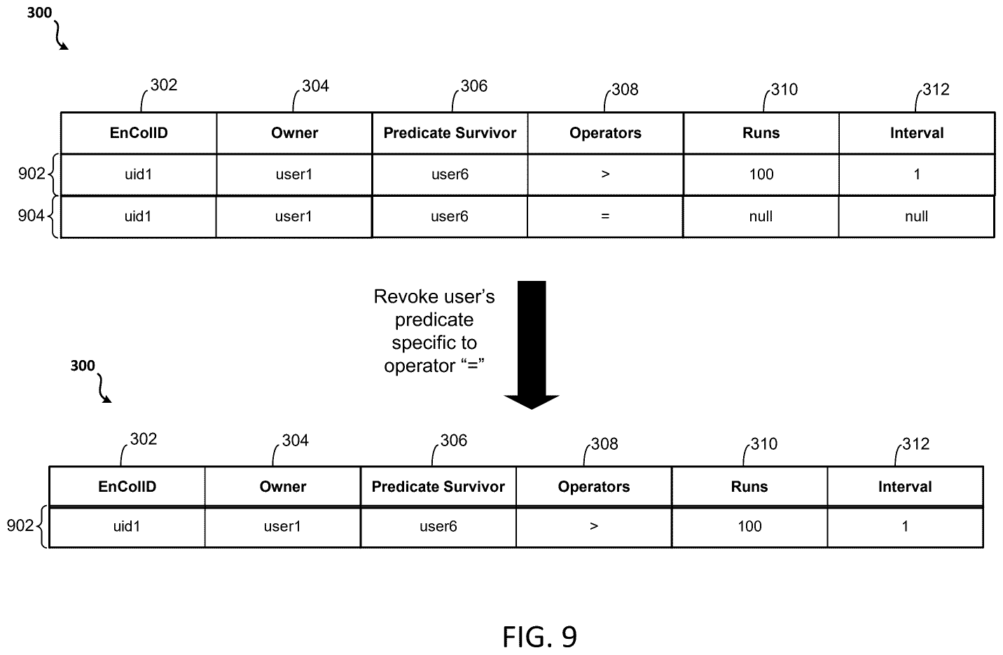

In embodiments, predicate access to a fine-grained privacy-preserving column can be partially revoked from a user. FIG. 9 shows an example predicate catalog table 300 that is modified to partially revoke predicate access to the fine-grained privacy-preserving column associated with the column ID “uid1” from a user associated with predicate survivor ID “user6.” The owner of the fine-grained privacy-preserving column may want to revoke the user's ability to query the fine-grained privacy-preserving column using a specific predicate operator (e.g., the operator “=”) or any other specific predicate operator. To revoke the user's predicate access to the fine-grained privacy-preserving column, the owner can send an instruction to revoke the user's predicate access to the fine-grained privacy-preserving column using the specific operator (e.g., the operator “=”) or any other specific operator. The instruction can be associated with identification information of the owner (e.g., owner ID “user1”).

The instruction can include identification information of the particular fine-grained privacy-preserving column (e.g., column ID “uid1”). The instruction can include identification information of the user from which the owner wants to completely revoke predicate access (e.g., predicate survivor ID “user6”). The instruction can include operator information indicating having an “=” value, indicating that the owner wants to revoke the user's ability to query the fine-grained privacy-preserving column using the specific predicate operator “=” or any other specific operator.

In response to receiving the instruction, the DBMS 108 can identify all rows in the predicate catalog table 300 that that match the identification information and the operator information indicated by the instruction. For example, the DBMS 108 can identify all rows in the predicate catalog table 300 that that include the column ID “uid1” as the identification information 302, the owner ID “user1” as the identification information 304, the predicate survivor ID “user6” as the identification information 306, and “=” or “null” (which includes =) as the operator 308.

In the example of FIG. 9, the row 904, but not the row 902, match the operator information included in the instruction. The row 902 does not match the operator information included in the instruction, as the row 902 includes a different operator than the specific predicate operator. The matching row, such as the row 904, can be deleted from the predicate catalog table 300. Deleting the matching row can revoke the user's predicate access to the fine-grained privacy-preserving column associated with the column ID “uid1” using the predicate operator “=.” In the example of FIG. 9, the row 902 will not be deleted because the row 902 does not match the operator information included in the instruction.

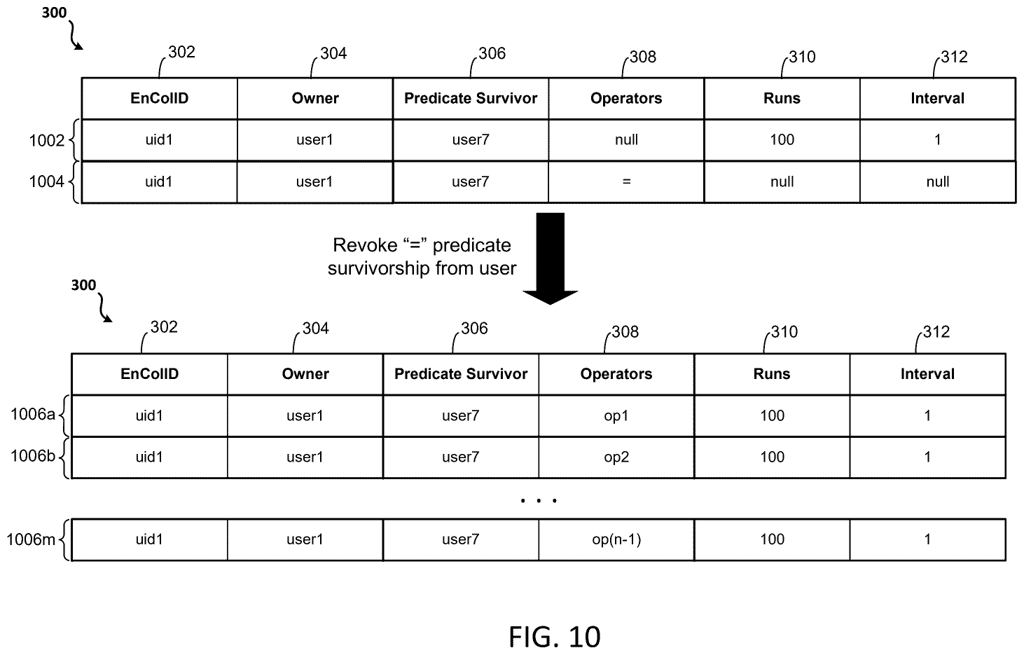

FIG. 10 shows another example of the predicate catalog table 300 being modified to partially revoke predicate access to the fine-grained privacy-preserving column associated with the column ID “uid1” from a user associated with predicate survivor ID “user7.” The owner of the fine-grained privacy-preserving column may want to revoke the user's ability to query the fine-grained privacy-preserving column using a specific predicate operator (e.g., the operator “=”) or any other specific operator. To revoke the user's predicate access to the fine-grained privacy-preserving column, the owner can send an instruction to revoke the user's predicate access to the fine-grained privacy-preserving column using the specific operator (e.g., the operator “=”) or any other specific operator. The instruction can be associated with the identification information of the owner (e.g., owner ID “user1”).

The instruction can include identification information of the particular fine-grained privacy-preserving column (e.g., column ID “uid1”). The instruction can include identification information of the user from which the owner wants to completely revoke predicate access (e.g., predicate survivor ID “user7”). The instruction can include operator information indicating an “=” value or other value indicative of any other specific predicate operator, indicating that the owner wants to revoke the user's ability to query the fine-grained privacy-preserving column using the specific predicate operator “=” or any other specific predicate operator.

In response to receiving the instruction, the DBMS 108 can identify all rows in the predicate catalog table 300 that that match the identification information and the operator information indicated by the instruction. For example, the DBMS 108 can identify all rows in the predicate catalog table 300 that that include “uid1” as the column ID information 302, “user1” as the owner information 304, “user6” as the predicate survivor information 306, and “=” or null (which includes =) as the operator information 308.

In the example of FIG. 10, both the row 1002 and the row 1004 match the identification information and the operator information indicated by the instruction. The row 1002 matches the operator information included in the instruction, as the row 1002 includes a null operator value, and a null operator value includes all available operators (other predicate operators in addition to “=”). The row 1004 exactly matches the operator information included in the instruction, as the row 1004 includes the specific operator “=.” The row 1004 can be deleted from the predicate catalog table 300 in response to determining that the row 1004 exactly matches the identification information and the operator information indicated by the instruction. In addition to deleting the row 1004, the predicate catalog table 300 can be updated by replacing the row 1002 with rows 1006a-m to reflect that the user associated with the predicate survivor ID “user7” has predicate access to the fine-grained privacy-preserving column using the other predicate operators (e.g., all other predicate operators except the “=” operator). For example, the row 1002 can be deleted and the rows 1006a-m can be added to the predicate catalog table 300. Each of the rows 1006a-m can grant the user associated with the predicate survivor ID “user7” predicate access to the fine-grained privacy-preserving column using one of the other predicate operators (e.g., all other predicate operators except for the “=” operator)

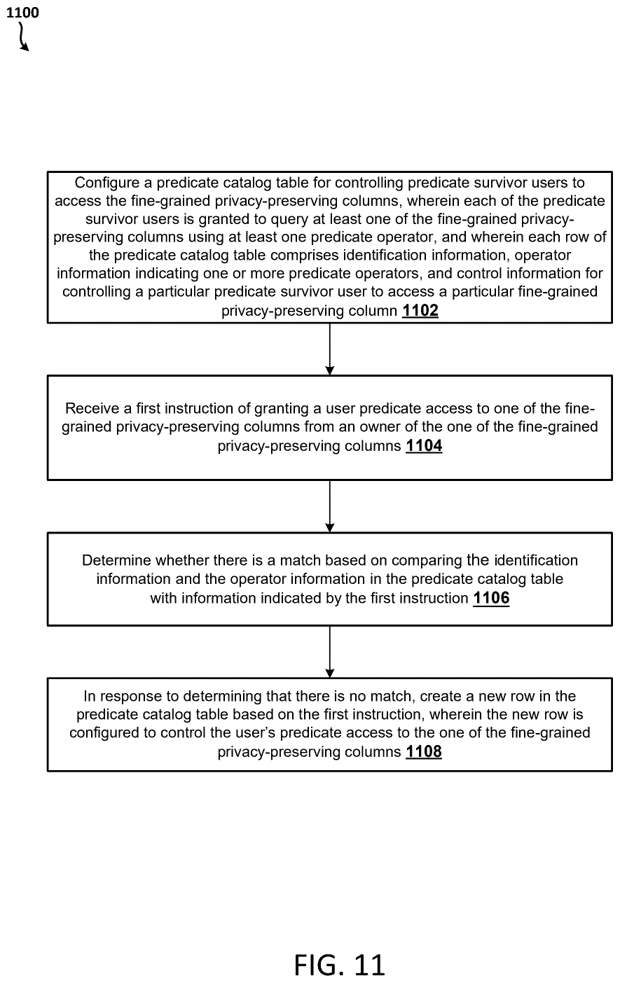

FIG. 11 illustrates an example process 1100 for implementing multiple security levels of control over predicate access to fine-grained privacy-preserving columns. Although depicted as a sequence of operations in FIG. 11, those of ordinary skill in the art will appreciate that various embodiments may add, remove, reorder, or modify the depicted operations.

At 1102, a predicate catalog table (e.g., predicate catalog table 300) can be configured. The predicate catalog table can be configured for controlling predicate survivor users to access fine-grained privacy-preserving columns. Each of the predicate survivor users can be granted access to query at least one of the fine-grained privacy-preserving columns using at least one predicate operator.

Each row of the predicate catalog table can include identification information (e.g., identification information 301). The identification information in each row of predicate catalog table can include identification information of the particular fine-grained privacy-preserving column (e.g., column ID information 302), identification information of an owner of the particular fine-grained privacy-preserving column (e.g., owner information 304), and identification information of the particular predicate survivor user (e.g., predicate survivor information 306). Each row of the predicate catalog table can include operator information (e.g., operator information 308) indicating one or more predicate operators. Each row of the predicate catalog table can include control information (e.g., control information 305) for controlling a particular predicate survivor user's access to a particular fine-grained privacy-preserving column. The control information in each row of the predicate catalog table can include information indicating a quantity limit (e.g., quantity limit information 310) that the particular predicate survivor user is allowed to query the particular fine-grained privacy-preserving column using the one or more predicate operators (e.g., a quantity of times that the predicate survivor user is allowed to query the particular fine-grained privacy-preserving column using the one or more predicate operators). The control information in each row of the predicate catalog table can include information indicating an interval (e.g., interval information 312) at which the quantity limit is to be reset (e.g., a time interval after which the quantity of times the particular predicate survivor user can run a query containing the predicate operator(s) is to be reset).

At 1104, a first instruction can be received. The first instruction can include an instruction to grant a user predicate access to one of the fine-grained privacy-preserving columns. The first instruction can be received from an owner of the one of the fine-grained privacy-preserving columns. The owner of the fine-grained privacy-preserving column is the only user that has permission to execute DCL operations associated with the fine-grained privacy-preserving column. At 1106, it can be determined whether there is a match based on comparing the identification information and the operator information in the predicate catalog table with information associated with the first instruction. Determining whether there is a match can include determining if any existing row in the predicate catalog table matches the first instruction. An existing row in the predicate catalog table can match the first instruction if the existing row includes the same identification information and operator information as the identification information and operator information indicated by the first instruction.

In embodiments, no match exists between any existing row in the predicate catalog table and the first instruction. At 1106, a new row can be created in the predicate catalog table. The new row can be created in the predicate catalog table in response to determining that there is no match. The new row can be created in the predicate catalog table based on the first instruction. For example, the new row can be created based on the identification information, the operator information, and the control information indicated by the first instruction. The new row can be configured to control the user's predicate access to the one of the fine-grained privacy-preserving columns.

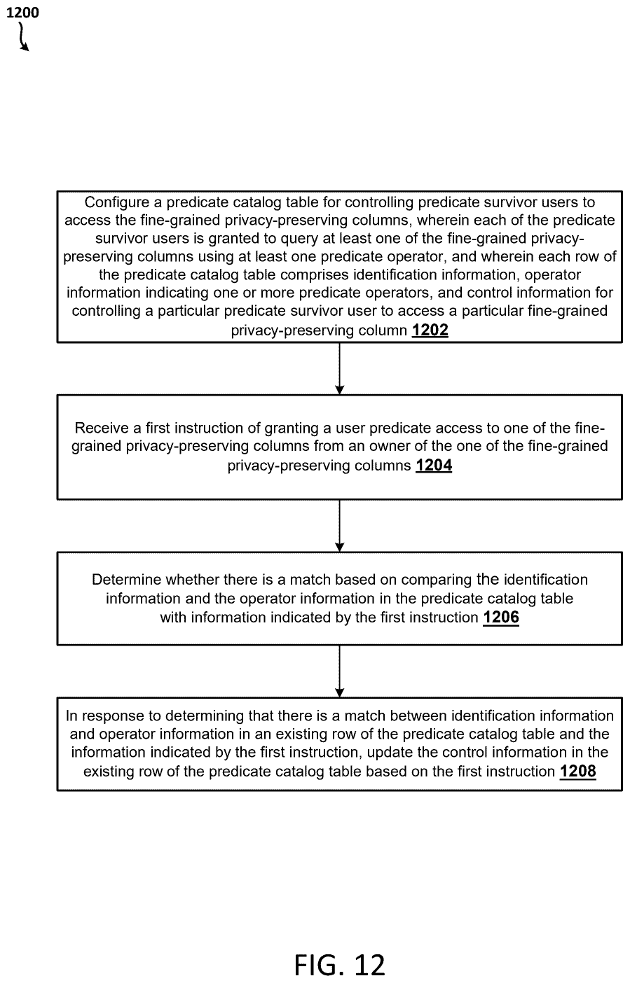

FIG. 12 illustrates an example process 1200 for implementing multiple security levels of control over predicate access to fine-grained privacy-preserving columns. Although depicted as a sequence of operations in FIG. 12, those of ordinary skill in the art will appreciate that various embodiments may add, remove, reorder, or modify the depicted operations.

At 1202, a predicate catalog table (e.g., predicate catalog table 300) can be configured. The predicate catalog table can be configured for controlling predicate survivor users to access fine-grained privacy-preserving columns. Each of the predicate survivor users can be granted access to query at least one of the fine-grained privacy-preserving columns using at least one predicate operator.

Each row of the predicate catalog table can include identification information (e.g., identification information 301). The identification information in each row of predicate catalog table can include identification information of the particular fine-grained privacy-preserving column (e.g., column ID information 302), identification information of an owner of the particular fine-grained privacy-preserving column (e.g., owner information 304), and identification information of the particular predicate survivor user (e.g., predicate survivor information 306). Each row of the predicate catalog table can include operator information (e.g., operator information 308) indicating one or more predicate operators. Each row of the predicate catalog table can include control information (e.g., control information 305) for controlling a particular predicate survivor user's access to a particular fine-grained privacy-preserving column. The control information in each row of the predicate catalog table can include information indicating a quantity limit (e.g., quantity limit information 310) that the particular predicate survivor user is allowed to query the particular fine-grained privacy-preserving column using the one or more predicate operators (e.g., a quantity of times that the predicate survivor user is allowed to query the particular fine-grained privacy-preserving column using the one or more predicate operators). The control information in each row of the predicate catalog table can include information indicating an interval (e.g., interval information 312) at which the quantity limit is to be reset (e.g., a time interval after which the quantity of times the particular predicate survivor user can run a query containing the predicate operator(s) is to be reset).

At 1204, a first instruction can be received. The first instruction can include an instruction to grant a user predicate access to one of the fine-grained privacy-preserving columns. The first instruction can be received from an owner of the one of the fine-grained privacy-preserving columns. The first instruction can be associated with the identification information of the owner. The owner of the fine-grained privacy-preserving column is the only user that has permission to execute DCL operations associated with the fine-grained privacy-preserving column. At 1206, it can be determined whether there is a match based on comparing the identification information and the operator information in the predicate catalog table with information associated with the first instruction. Determining whether there is a match can include determining if any existing row in the predicate catalog table matches the first instruction. An existing row in the predicate catalog table can match the first instruction if the existing row includes the same identification information and operator information as the identification information and operator information indicated by the first instruction.

In embodiments, a match exists between an existing row in the predicate catalog table and the first instruction. At 1208, the control information in the existing row of the predicate catalog table can be updated. The control information in the existing row of the predicate catalog table can be updated in response to determining that there is a match between identification information and operator information in the existing row of the predicate catalog table and the information associated with the first instruction. The control information in the existing row of the predicate catalog table can be updated based on the first instruction.

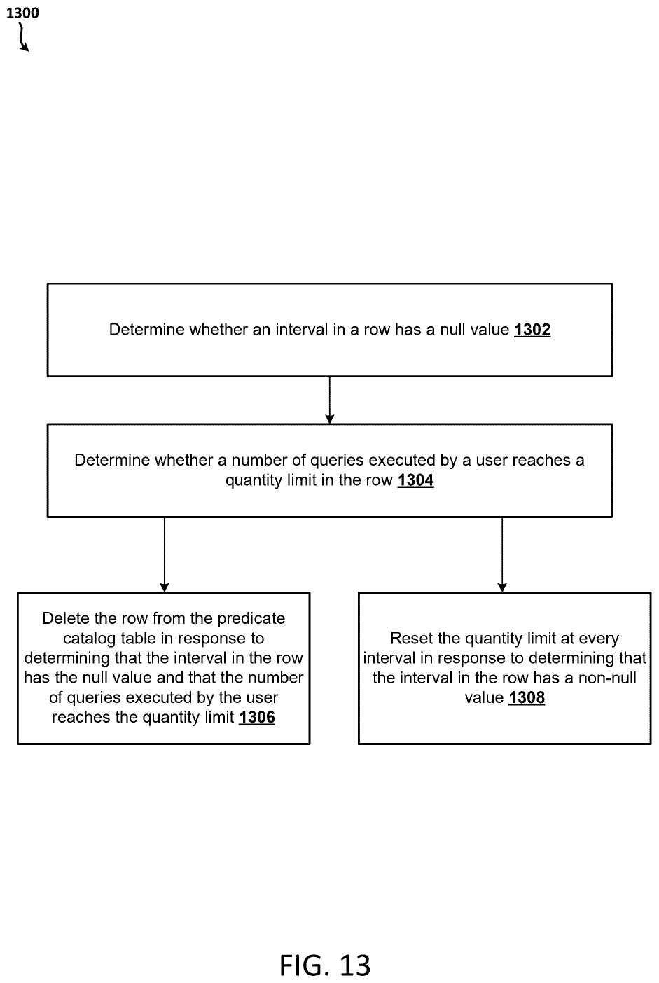

FIG. 13 illustrates an example process 1300 for implementing multiple security levels of control over predicate access to fine-grained privacy-preserving columns. Although depicted as a sequence of operations in FIG. 13, those of ordinary skill in the art will appreciate that various embodiments may add, remove, reorder, or modify the depicted operations.

A row in a predicate catalog table (e.g., predicate catalog table 300) can include control information (e.g., control information 305) that indicates a quantity limit (e.g., quantity limit information 310) that a particular predicate survivor user is allowed to query a particular fine-grained privacy-preserving column using one or more specified predicate operators, and an interval (e.g., interval information 312). At 1302, it can be determined whether an interval in a row has a null value. At 1304, it can be determined whether a number of queries executed by the particular predicate survivor user has reached the quantity limit indicated in the row. For example, it can be determined whether the user has executed the allowed number of queries. At 1306, the row can be deleted from the predicate catalog table. The row can be deleted from the predicate catalog table in response to determining that the interval in the row has the null value and that the number of queries executed by the user reaches the quantity limit. At 1308, the quantity limit can be reset at every interval in response to determining that the interval in the row has a non-null value

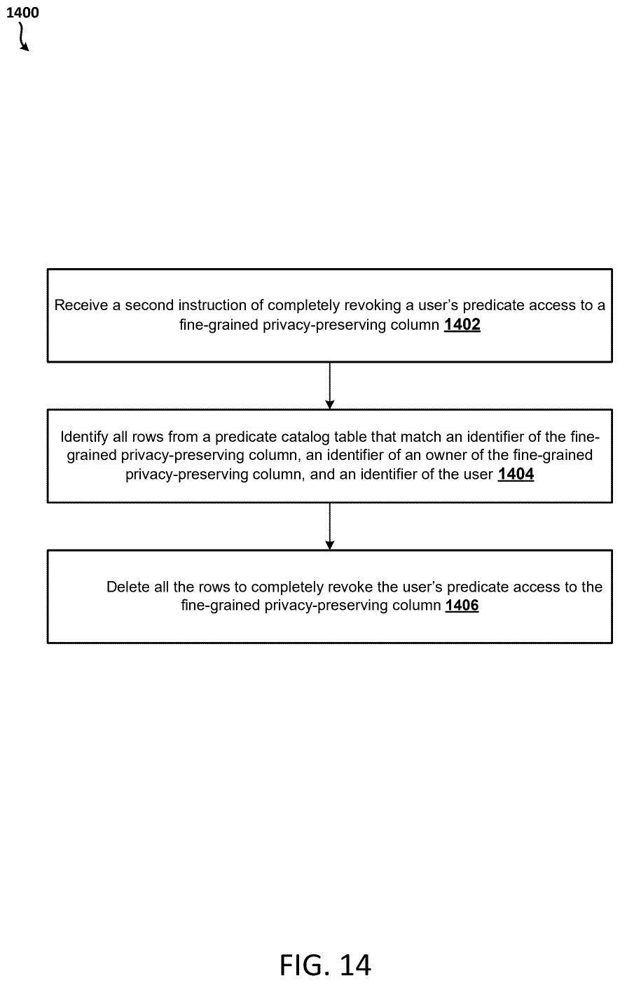

FIG. 14 illustrates an example process 1400 for implementing multiple security levels of control over predicate access to fine-grained privacy-preserving columns. Although depicted as a sequence of operations in FIG. 14, those of ordinary skill in the art will appreciate that various embodiments may add, remove, reorder, or modify the depicted operations.

Predicate access to a fine-grained privacy-preserving column can be revoked from a user. For example, the owner may have granted the user predicate access to the fine-grained privacy-preserving column accidentally (e.g., by mistake). In embodiments, the owner of a fine-grained privacy-preserving column may want to completely revoke the user's predicate access to the fine-grained privacy-preserving column. For example, the owner of the fine-grained privacy-preserving column may want to revoke the user's ability to query the fine-grained privacy-preserving column using any predicate operator.

To completely revoke the user's predicate access to the fine-grained privacy-preserving column, the owner can send a second instruction (e.g., to the DBMS 108) to completely revoke the user's predicate access to the fine-grained privacy-preserving column. The second instruction can be associated with the identification information of the owner. At 1402, a second instruction of completely revoking a user's predicate access to a fine-grained privacy-preserving column can be received. The second instruction can include identification information, such as identification information of the particular fine-grained privacy-preserving column and identification information of the user from which the owner wants to revoke predicate access. The second instruction can include operator information having a null value, indicating that the owner wants to revoke the user's ability to query the fine-grained privacy-preserving column using any predicate operator (not just a specific predicate operator).

At 1404, all rows from a predicate catalog table (e.g., predicate catalog table 300) that match an identifier of the fine-grained privacy-preserving column, an identifier of an owner of the fine-grained privacy-preserving column, and an identifier of the user can be identified. All of the rows that match an identifier of the fine-grained privacy-preserving column, an identifier of an owner of the fine-grained privacy-preserving column, and an identifier of the user can be identified in response to receiving the second instruction. At 1406, all of the identified rows can be deleted. Deleting all of the identified rows can completely revoke the user's predicate access to the fine-grained privacy-preserving column.

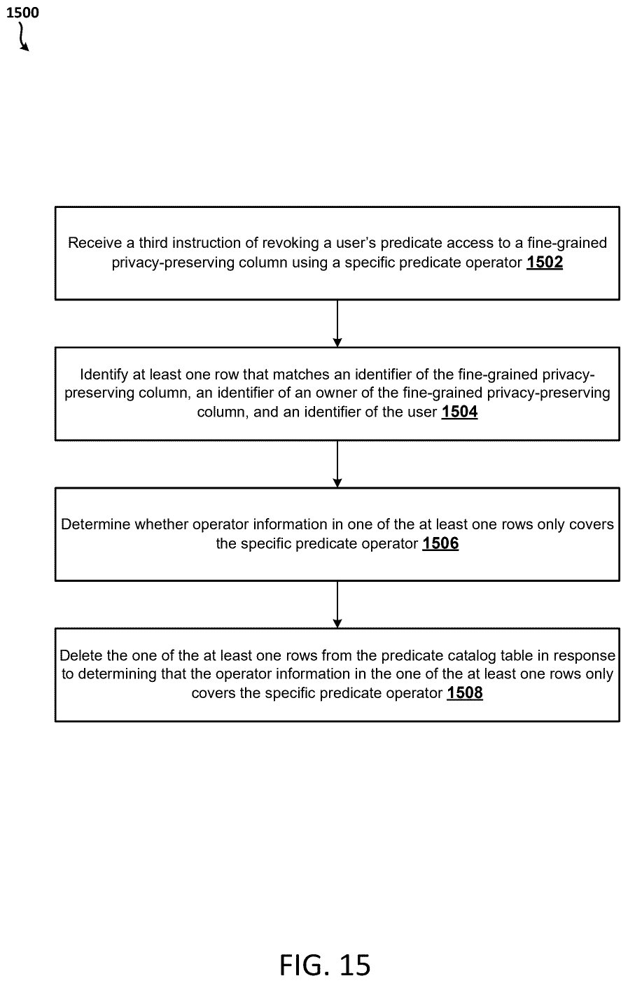

FIG. 15 illustrates an example process 1500 for implementing multiple security levels of control over predicate access to fine-grained privacy-preserving columns. Although depicted as a sequence of operations in FIG. 15, those of ordinary skill in the art will appreciate that various embodiments may add, remove, reorder, or modify the depicted operations.

Predicate access to a fine-grained privacy-preserving column can be revoked from a user. For example, the owner may have granted the user predicate access to the fine-grained privacy-preserving column accidentally (e.g., by mistake). In embodiments, the owner of a fine-grained privacy-preserving column may want to revoke the user's predicate access to the fine-grained privacy-preserving column using a specific predicate operator.

To revoke the user's predicate access to the fine-grained privacy-preserving column using a specific predicate operator, the owner can send a third instruction (e.g., to the DBMS 108) to revoke the user's predicate access to the fine-grained privacy-preserving column using the specific predicate operator. The third instruction can be associated with the identification information of the owner. At 1502, a third instruction of revoking a user's predicate access to a fine-grained privacy-preserving column using the specific predicate operator can be received. The third instruction can include identification information, such as identification information of the particular fine-grained privacy-preserving column and identification information of the user from which the owner wants to revoke predicate access. The third instruction can include operator information indicating the specific predicate operator.

At 1504, at least one row from a predicate catalog table (e.g., predicate catalog table 300) that matches an identifier of the fine-grained privacy-preserving column, an identifier of an owner of the fine-grained privacy-preserving column, and an identifier of the user can be identified. The at least one rows that match an identifier of the fine-grained privacy-preserving column, an identifier of an owner of the fine-grained privacy-preserving column, and an identifier of the user can be identified in response to receiving the third instruction. At 1506, it can be determined whether operator information in one of the at least one rows only covers the specific predicate operator. At 1508, the one of the at least one rows can be deleted from the predicate catalog table. The one of the at least one rows can be deleted from the predicate catalog table can be deleted in response to determining that the operator information in the one of the at least one rows only covers the specific predicate operator.

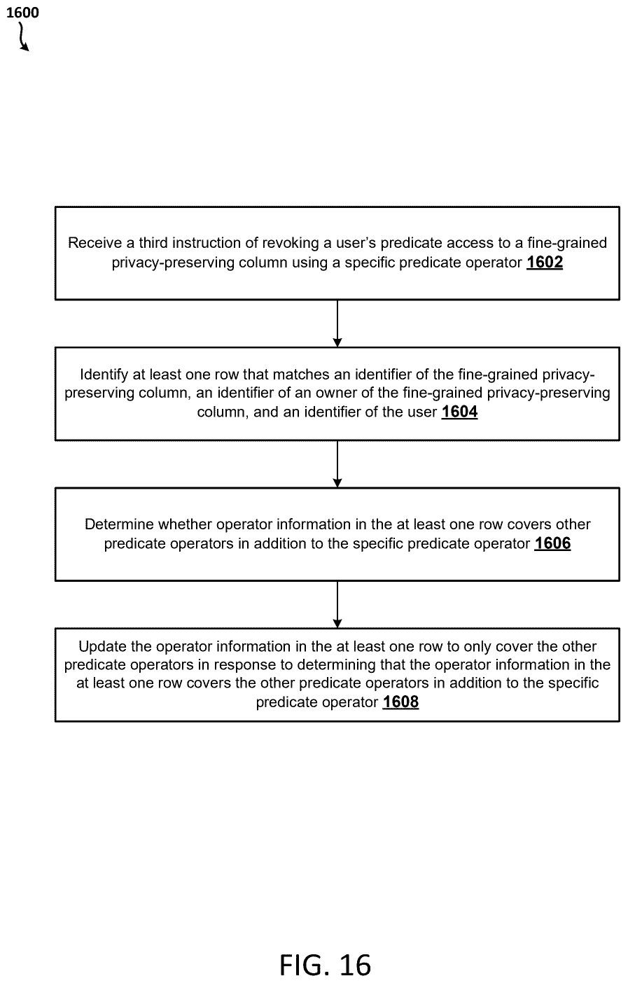

FIG. 16 illustrates an example process 1600 for implementing multiple security levels of control over predicate access to fine-grained privacy-preserving columns. Although depicted as a sequence of operations in FIG. 16, those of ordinary skill in the art will appreciate that various embodiments may add, remove, reorder, or modify the depicted operations.

Predicate access to a fine-grained privacy-preserving column can be revoked from a user. For example, the owner may have granted the user predicate access to the fine-grained privacy-preserving column accidentally (e.g., by mistake). In embodiments, the owner of a fine-grained privacy-preserving column may want to revoke the user's predicate access to the fine-grained privacy-preserving column using a specific predicate operator.

To revoke the user's predicate access to the fine-grained privacy-preserving column using a specific predicate operator, the owner can send a third instruction (e.g., to the DBMS 108) to revoke the user's predicate access to the fine-grained privacy-preserving column using the specific predicate operator. The third instruction can be associated with identification information of the owner. At 1602, a third instruction of revoking a user's predicate access to a fine-grained privacy-preserving column using the specific predicate operator can be received. The third instruction can include identification information, such as identification information of the particular fine-grained privacy-preserving column and identification information of the user from which the owner wants to revoke predicate access. The third instruction can include operator information indicating the specific predicate operator.

At 1604, at least one row from a predicate catalog table (e.g., predicate catalog table 300) that matches an identifier of the fine-grained privacy-preserving column, an identifier of an owner of the fine-grained privacy-preserving column, and an identifier of the user can be identified. The at least one rows that match an identifier of the fine-grained privacy-preserving column, an identifier of an owner of the fine-grained privacy-preserving column, and an identifier of the user can be identified in response to receiving the third instruction. At 1606, it can be determined whether operator information in one of the at least one rows covers other predicate operators in addition to the specific predicate operator. At 1608, the operator information in the at least one row can be updated to only cover the other predicate operators. The operator information in the at least one row can be updated to only cover the other predicate operator in response to determining that the operator information in the one of the at least one rows covers the other predicate operators in addition to the specific predicate operator.

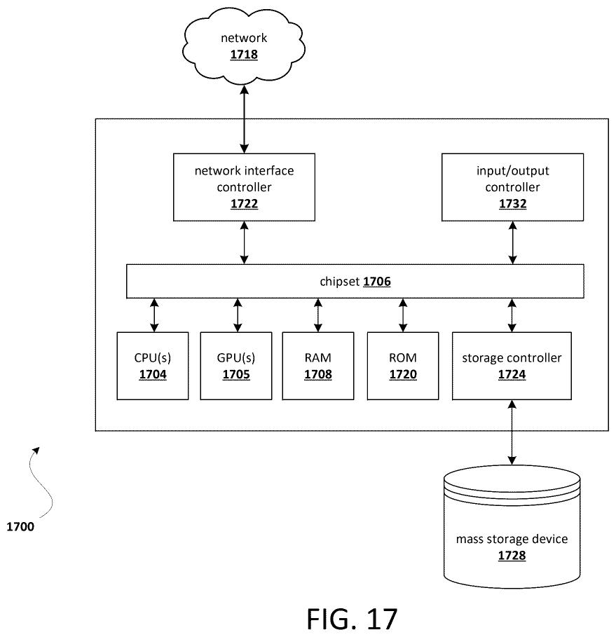

FIG. 17 illustrates a computing device that may be used in various aspects, such as the model(s), components, and/or devices depicted in FIGS. 1 and 2. With regard to FIGS. 1 and 2, any or all of the components may each be implemented by one or more instance of a computing device 1700 of FIG. 17. The computer architecture shown in FIG. 17 shows a conventional server computer, workstation, desktop computer, laptop, tablet, network appliance, PDA, e-reader, digital cellular phone, or other computing node, and may be utilized to execute any aspects of the computers described herein, such as to implement the methods described herein.

The computing device 1700 may include a baseboard, or “motherboard,” which is a printed circuit board to which a multitude of components or devices may be connected by way of a system bus or other electrical communication paths. One or more central processing units (CPUs) 1704 may operate in conjunction with a chipset 1706. The CPU(s) 1704 may be standard programmable processors that perform arithmetic and logical operations necessary for the operation of the computing device 1700.

The CPU(s) 1704 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 1704 may be augmented with or replaced by other processing units, such as GPU(s) 1705. The GPU(s) 1705 may comprise processing units specialized for but not necessarily limited to highly parallel computations, such as graphics and other visualization-related processing.

A chipset 1706 may provide an interface between the CPU(s) 1704 and the remainder of the components and devices on the baseboard. The chipset 1706 may provide an interface to a random-access memory (RAM) 1708 used as the main memory in the computing device 1700. The chipset 1706 may further provide an interface to a computer-readable storage medium, such as a read-only memory (ROM) 1720 or non-volatile RAM (NVRAM) (not shown), for storing basic routines that may help to start up the computing device 1700 and to transfer information between the various components and devices. ROM 1720 or NVRAM may also store other software components necessary for the operation of the computing device 1700 in accordance with the aspects described herein.

The computing device 1700 may operate in a networked environment using logical connections to remote computing nodes and computer systems through local area network (LAN). The chipset 1706 may include functionality for providing network connectivity through a network interface controller (NIC) 1722, such as a gigabit Ethernet adapter. A NIC 1722 may be capable of connecting the computing device 1700 to other computing nodes over a network 1716. It should be appreciated that multiple NICs 1722 may be present in the computing device 1700, connecting the computing device to other types of networks and remote computer systems.

The computing device 1700 may be connected to a mass storage device 1728 that provides non-volatile storage for the computer. The mass storage device 1728 may store system programs, application programs, other program modules, and data, which have been described in greater detail herein. The mass storage device 1728 may be connected to the computing device 1700 through a storage controller 1724 connected to the chipset 1706. The mass storage device 1728 may consist of one or more physical storage units. The mass storage device 1728 may comprise a management component 1710. A storage controller 1724 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 1700 may store data on the mass storage device 1728 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 1728 is characterized as primary or secondary storage and the like.

For example, the computing device 1700 may store information to the mass storage device 1728 by issuing instructions through a storage controller 1724 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 1700 may further read information from the mass storage device 1728 by detecting the physical states or characteristics of one or more particular locations within the physical storage units.

In addition to the mass storage device 1728 described above, the computing device 1700 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 1700.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 1728 depicted in FIG. 17, may store an operating system utilized to control the operation of the computing device 1700. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 1728 may store other system or application programs and data utilized by the computing device 1700.

The mass storage device 1728 or other computer-readable storage media may also be encoded with computer-executable instructions, which, when loaded into the computing device 1700, transforms the computing device from a general-purpose computing system into a special-purpose computer capable of implementing the aspects described herein. These computer-executable instructions transform the computing device 1700 by specifying how the CPU(s) 1704 transition between states, as described above. The computing device 1700 may have access to computer-readable storage media storing computer-executable instructions, which, when executed by the computing device 1700, may perform the methods described herein.

A computing device, such as the computing device 1700 depicted in FIG. 17, may also include an input/output controller 1732 for receiving and processing input from a number of input devices, such as a keyboard, a mouse, a touchpad, a touch screen, an electronic stylus, or other type of input device. Similarly, an input/output controller 1732 may provide output to a display, such as a computer monitor, a flat-panel display, a digital projector, a printer, a plotter, or other type of output device. It will be appreciated that the computing device 1700 may not include all of the components shown in FIG. 17, may include other components that are not explicitly shown in FIG. 17, or may utilize an architecture completely different than that shown in FIG. 17.

As described herein, a computing device may be a physical computing device, such as the computing device 1700 of FIG. 17. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

The present methods and systems may be understood more readily by reference to the following detailed description of preferred embodiments and the examples included therein and to the Figures and their descriptions.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses, and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its operations be performed in a specific order. Accordingly, where a method claim does not actually recite an order to be followed by its operations or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method of implementing multiple security levels of control over predicate access to fine-grained privacy-preserving columns, comprising:
configuring a predicate catalog table for controlling predicate survivor users to access the fine-grained privacy-preserving columns, wherein each of the predicate survivor users is granted to query at least one of the fine-grained privacy-preserving columns using at least one predicate operator, and wherein each row of the predicate catalog table comprises identification information, operator information indicating one or more predicate operators, and control information for controlling a particular predicate survivor user to access a particular fine-grained privacy-preserving column;
receiving a first instruction of granting a user predicate access to one of the fine-grained privacy-preserving columns from an owner of the one of the fine-grained privacy-preserving columns;
determining whether there is a match based on comparing the identification information and the operator information in the predicate catalog table with information indicated by the first instruction; and
in response to determining that there is no match, creating a new row in the predicate catalog table based on the first instruction, wherein the new row is configured to control the user's predicate access to the one of the fine-grained privacy-preserving columns.

2. The method of claim 1, further comprising:
in response to determining that there is a match between identification information and operator information in an existing row of the predicate catalog table and the information indicated by the first instruction, updating the control information in the existing row of the predicate catalog table based on the first instruction.

3. The method of claim 1, wherein the identification information in each row of predicate catalog table comprises information of identifying the particular fine-grained privacy-preserving column, identifying an owner of the particular fine-grained privacy-preserving column, and identifying the particular predicate survivor user, and wherein the control information in each row of the predicate catalog table comprises a quantity limit that the particular predicate survivor user is allowed to query the particular fine-grained privacy-preserving column using the one or more predicate operators and an interval at which the quantity limit is to be reset.

4. The method of claim 1, further comprising:
determining whether an interval in the new row has a null value; and
determining whether a number of queries executed by the user reaches a quantity limit in the new row.

5. The method of claim 4, further comprising:
deleting the new row from the predicate catalog table in response to determining that the interval in the new row has the null value and that the number of queries executed by the first user reaches the quantity limit.

6. The method of claim 4, further comprising:
resetting the quantity limit at every interval in response to determining that the interval in the new row has a non-null value.

7. The method of claim 1, further comprising:
receiving a second instruction of completely revoking the user's predicate access to the one of the fine-grained privacy-preserving columns;
identifying all rows that match an identifier of the one of the fine-grained privacy-preserving columns, an identifier of the owner of the one of the fine-grained privacy-preserving columns, and an identifier of the user; and
deleting all the rows to completely revoke the user's predicate access to the one of the fine-grained privacy-preserving columns.

8. The method of claim 1, further comprising:
receiving a third instruction of revoking the user's predicate access to the one of the fine-grained privacy-preserving columns using a specific predicate operator;
identifying at least one row that matches an identifier of the one of the fine-grained privacy-preserving columns, an identifier of the owner of the one of the fine-grained privacy-preserving columns, and an identifier of the user.

9. The method of claim 8, further comprising:
determining whether operator information in one of the at least one rows only covers the specific predicate operator; and
deleting the one of the at least one row from the predicate catalog table in response to determining that the operator information in the one of the at least one row only covers the specific predicate operator.

10. The method of claim 8, further comprising:
determining whether operator information in the at least one row covers other predicate operators in addition to the specific predicate operator; and
updating the operator information in the at least one row to only cover the other predicate operators in response to determining that the operator information in the at least one row covers other predicate operators in addition to the specific predicate operator.

11. A system of implementing multiple security levels of control over predicate access to fine-grained privacy-preserving columns, comprising:
at least one processor; and
at least one memory communicatively coupled to the at least one processor and comprising computer-readable instructions that upon execution by the at least one processor cause the at least one processor to perform operations comprising:
configuring a predicate catalog table for controlling predicate survivor users to access the fine-grained privacy-preserving columns, wherein each of the predicate survivor users is granted to query at least one of the fine-grained privacy-preserving columns using at least one predicate operator, and wherein each row of the predicate catalog table comprises identification information, operator information indicating one or more predicate operators, and control information for controlling a particular predicate survivor user to access a particular fine-grained privacy-preserving column;
receiving a first instruction of granting a user predicate access to one of the fine-grained privacy-preserving columns from an owner of the one of the fine-grained privacy-preserving columns;
determining whether there is a match based on comparing the identification information and the operator information in the predicate catalog table with information indicated by the first instruction; and
in response to determining that there is no match, creating a new row in the predicate catalog table based on the first instruction, wherein the new row is configured to control the user's predicate access to the one of the fine-grained privacy-preserving columns.

12. The system of claim 11, the operations further comprising:
in response to determining that there is a match between identification information and operator information in an existing row of the predicate catalog table and the information indicated by the first instruction, updating the control information in the existing row of the predicate catalog table based on the first instruction.

13. The system of claim 11, wherein the identification information in each row of predicate catalog table comprises information of identifying the particular fine-grained privacy-preserving column, identifying an owner of the particular fine-grained privacy-preserving column, and identifying the particular predicate survivor user, and wherein the control information in each row of the predicate catalog table comprises a quantity limit that the particular predicate survivor user is allowed to query the particular fine-grained privacy-preserving column using the one or more predicate operators and an interval at which the quantity limit is to be reset.

14. The system of claim 11, the operations further comprising:
receiving a second instruction of completely revoking the user's predicate access to the one of the fine-grained privacy-preserving columns;
identifying all rows that match an identifier of the one of the fine-grained privacy-preserving columns, an identifier of the owner of the one of the fine-grained privacy-preserving columns, and an identifier of the user; and
deleting all the rows to completely revoke the user's predicate access to the one of the fine-grained privacy-preserving columns.

15. The system of claim 11, the operations further comprising:
receiving a third instruction of revoking the user's predicate access to the one of the fine-grained privacy-preserving columns using a specific predicate operator;
identifying at least one row that matches an identifier of the one of the fine-grained privacy-preserving columns, an identifier of the owner of the one of the fine-grained privacy-preserving columns, and an identifier of the user;
determining whether operator information in one of the at least one rows only covers the specific predicate operator; and
deleting the one of the at least one row from the predicate catalog table in response to determining that the operator information in the one of the at least one row only covers the specific predicate operator.

16. A non-transitory computer-readable storage medium, storing computer-readable instructions that upon execution by a processor cause the processor to implement operations comprising:
configuring a predicate catalog table for controlling predicate survivor users to access the fine-grained privacy-preserving columns, wherein each of the predicate survivor users is granted to query at least one of the fine-grained privacy-preserving columns using at least one predicate operator, and wherein each row of the predicate catalog table comprises identification information, operator information indicating one or more predicate operators, and control information for controlling a particular predicate survivor user to access a particular fine-grained privacy-preserving column;
receiving a first instruction of granting a user predicate access to one of the fine-grained privacy-preserving columns from an owner of the one of the fine-grained privacy-preserving columns;
determining whether there is a match based on comparing the identification information and the operator information in the predicate catalog table with information indicated by the first instruction; and
in response to determining that there is no match, creating a new row in the predicate catalog table based on the first instruction, wherein the new row is configured to control the user's predicate access to the one of the fine-grained privacy-preserving columns.

17. The non-transitory computer-readable storage medium of claim 16, the operations further comprising:
in response to determining that there is a match between identification information and operator information in an existing row of the predicate catalog table and the information indicated by the first instruction, updating the control information in the existing row of the predicate catalog table based on the first instruction.

18. The non-transitory computer-readable storage medium of claim 16, wherein the identification information in each row of predicate catalog table comprises information of identifying the particular fine-grained privacy-preserving column, identifying an owner of the particular fine-grained privacy-preserving column, and identifying the particular predicate survivor user, and wherein the control information in each row of the predicate catalog table comprises a quantity limit that the particular predicate survivor user is allowed to query the particular fine-grained privacy-preserving column using the one or more predicate operators and an interval at which the quantity limit is to be reset.

19. The non-transitory computer-readable storage medium of claim 16, the operations further comprising:
receiving a second instruction of completely revoking the user's predicate access to the one of the fine-grained privacy-preserving columns;
identifying all rows that match an identifier of the one of the fine-grained privacy-preserving columns, an identifier of the owner of the one of the fine-grained privacy-preserving columns, and an identifier of the user; and
deleting all the rows to completely revoke the user's predicate access to the one of the fine-grained privacy-preserving columns.

20. The non-transitory computer-readable storage medium of claim 16, the operations further comprising:
receiving a third instruction of revoking the user's predicate access to the one of the fine-grained privacy-preserving columns using a specific predicate operator;
identifying at least one row that matches an identifier of the one of the fine-grained privacy-preserving columns, an identifier of the owner of the one of the fine-grained privacy-preserving columns, and an identifier of the user;
determining whether operator information in one of the at least one rows only covers the specific predicate operator; and
deleting the one of the at least one row from the predicate catalog table in response to determining that the operator information in the one of the at least one row only covers the specific predicate operator.
